(19) United States
(12) Patent Application Publication
(10) Pub. No.: US 2009/0116662 A1
(43) Pub. Date: May 7, 2009

(54) AUDIO PROCESSING METHOD AND SYSTEM

(75) Inventor: Li-Te Wu, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: FORTEMEDIA, INC., Cupertino, CA (US)

(21) Appl. No.: 11/935,489

(22) Filed: Nov. 6, 2007

(51) Int. Cl. H04B 15/00

(52) U.S. Cl. 381/94.2; 381/94.1

(57) ABSTRACT

An audio processing method used in a microphone is provided. Firstly, a sound signal is received. Next, the sound signal is transduced to a first voltage signal. The first voltage signal is interfered with by a second voltage signal resulting from electromagnetic wave penetrating into the microphone. Next, the second voltage signal is filtered out from the interfered first voltage signal. Finally, the filtered first voltage signal is amplified.

### BACKGROUND OF THE INVENTION

1. Field of the Invention

The invention relates to a microphone, and more particularly to an audio processing method and system eliminating electromagnetic wave interference.

2. Description of the Related Art

An electret condenser microphone (ECM) is the most popular microphone in consumer devices due to its low cost and small size. FIG. 1 shows an explosion view of an ECM. ECM 100 comprises a metal cabinet 102, a diaphragm 104, a backplate 106, a microphone IC 108, and a printed circuit board (PCB) 110. There is a sound hole 112 on the top of metal cabinet 102, so the sound signal can propagate through the sound hole 112. The received sound signal would vibrate diaphragm 104 and change the distance between diaphragm 104 and backplate 106 to transduce the received sound signal to a voltage signal. Microphone IC 108 comprises a preamplifier configured to receive the transduced voltage signal and amplify it. PCB 110 is used to support microphone IC 108 and provide mechanical protection.

One major drawback of the preamplifier, however, is that it is easily interfered with by radio-frequency (RF) signals due to its non-linear characteristics. A device is called “non-linear” if the device receives a frequency component and thus generates other frequency components. On the contrary, a device is called “linear” if the device receives a frequency component and does not generate other frequency components. FIG. 2 shows an example of a basic preamplifier consisting of a junction field effect transistor (JFET) 202. JFET 202 is biased as a common source amplifier, and its DC bias voltage is the ground voltage due to the high resistance of resistor 203. Load resistor 204 is coupled between the power supply VDD and the drain of JFET 202. The output gain (i.e. Vo/Vi) in small-signal model is Gₘ×R_{L}, where Gₘ is the trans-conductance of JFET 202 and R_{L} is the resistance of the load resistor 204. Suppose that the input of the preamplifier (i.e. the gate of JFET 202) is interfered with by two RF signals with frequency f1 and f2. The DC model for JFET 202 in saturation region is:

$$\begin{matrix}{I}_{D} = {k ( {V}_{i} - {V}_{TH} )}^{2} \\ = {( {A}_{1} sin ( 2 π {f}_{1} t ) + {A}_{2} sin ( 2 π {f}_{2} t ) - {V}_{TH} )}^{2} \\ = {I}_{D , DC} + {I}_{D , Linear} + {I}_{D , harmonic} + {I}_{D , intermodulation}\end{matrix}$$

where k and V_{TH} are the parameters of JFET 202, A₁ and A₂ are respectively the amplitude of the two RF signals, and t represents time. The output current I_{D} therefore comprises the following four terms:

$$\begin{matrix}DC term \text{:} & {I}_{D , DC} = {kV}_{TH}^{2} \\ Linear term \text{:} & {I}_{D , Linear} = 2 {kV}_{TH} [ {A}_{1} sin ( 2 π {f}_{1} t ) + {A}_{2} sin ( 2 π {f}_{2} t ) ] \\ Harmonic term \text{:} & {I}_{D , Harmonic} = k ⌊ {A}_{1}^{2} {sin}^{2} ( 2 π {f}_{1} t ) + {A}_{2}^{2} {sin}^{2} ( 2 π {f}_{2} t ) ⌋ \\ Inter \text{-} modulation term & \begin{matrix}{I}_{D , Intermodulation} = 2 {kA}_{1} {A}_{2} \\ [ sin ( 2 π {f}_{1} t ) sin ( 2 π {f}_{2} t ) ] \\ = {kA}_{1} {A}_{2} \\ [ cos ( 2 π ( {f}_{1} - {f}_{2} ) ) - \\ cos ( 2 π ( {f}_{1} + {f}_{2} ) t ]\end{matrix}\end{matrix}$$

Now suppose that f1=1800 MHz and f2=1800.001 MHz. The linear term, the harmonic term, and the higher frequency component of the inter-modulation term (i.e. f₁+f₂) are much higher than the frequency range that JFET 202 can handle and will be attenuated by JEFT 202. The lower frequency component of the inter-modulation term (i.e. f₁-f₂), however, will introduce an interfered peak at 1 kHz within the voice band (20 Hz˜20 kHz) and result in an undesired tone due to the inter-modulation of the received sound signal.

For example, FIG. 3(B) shows an example of frequency spectrum of a sound signal A and two RF signals B and C before passing through the preamplifier. The frequencies of the RF signals B and C are much larger than that of the sound signal A. FIG. 3(C) is the frequency spectrum after the sound signal A and the RF signals B and C pass through the preamplifier. As a result, the RF signals B and C result in a DC tone (not shown), an inter-modulation tone D, and harmonic tones E and F. Since the inter-modulation tone D is near the sound signal A, it will interfere with the sound signal A, i.e. a person will perceive the sound signal A along with the inter-modulation tone D.

Therefore, a heretofore unaddressed need exists in the art to address the aforementioned deficiencies and inadequacies.

### BRIEF SUMMARY OF THE INVENTION

Certain aspects commensurate in scope with the originally claimed invention are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Audio processing methods and audio processing systems are provided. An exemplary embodiment of an audio processing method comprises receiving a sound signal, transducing the sound signal to a first voltage signal, wherein the first voltage signal is interfered with by a second voltage signal resulting from an electromagnetic wave penetrating into the microphone, filtering out the second voltage signal from the interfered first voltage signal, and amplifying the filtered first voltage signal.

An exemplary embodiment of an audio processing system comprises a transducer, configured to transduce a sound signal to a first voltage signal, wherein the first voltage signal is interfered with by a second voltage signal resulting from an electromagnetic wave, a filter, electrically coupled to the transducer, configured to filter out the second voltage signal, and a preamplifier, electrically coupled to the filter, configured to amplify the first voltage signal.

### BRIEF DESCRIPTION OF THE DRAWINGS

The invention can be more fully understood by reading the subsequent detailed description and examples with references made to the accompanying drawings, wherein:

FIG. 1 is an embodiment of an explosion view of an ECM;

FIG. 2 shows an example of a basic preamplifier;

FIG. 3(A) is a preferred embodiment of an ECM according to the invention;

FIG. 3(B) shows an example of frequency spectrum before the signals pass through the preamplifier;

FIGS. 3(C) and 3(D) show examples of frequency spectrum after the signals pass through the preamplifier with and without the RF filter;

FIG. 4 shows four embodiments of RF filer 308 of resistor-capacitor networks;

FIG. 5 shows an exemplary frequency response of microphone 300 with and without RF filter 308; and

FIG. 6 is an embodiment of an audio processing method according to the invention.

### DETAILED DESCRIPTION OF THE INVENTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacturing for those of ordinary skill in the art having the benefit of this disclosure.

In the following detailed description, reference is made to the accompanying drawings which form a part hereof, shown by way of illustration of specific embodiments. These embodiments are described in sufficient detail to enable those of ordinary skill in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures corresponds to the Figure number, with the exception that the same reference number is used throughout to refer to an identical component which appears in multiple figures. It should be understood that the many of the elements described and illustrated throughout the specification are functional in nature and may be embodied in one or more physical entities or may take other forms beyond those described or depicted.

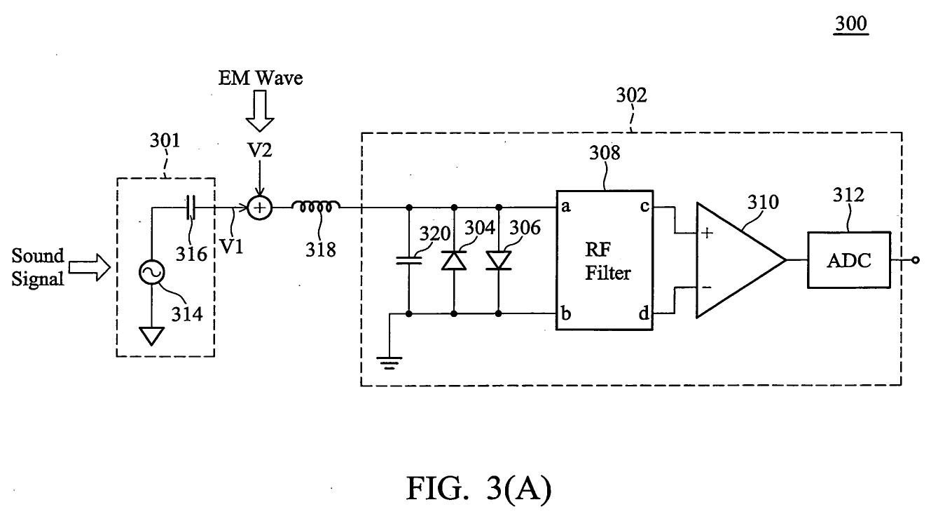

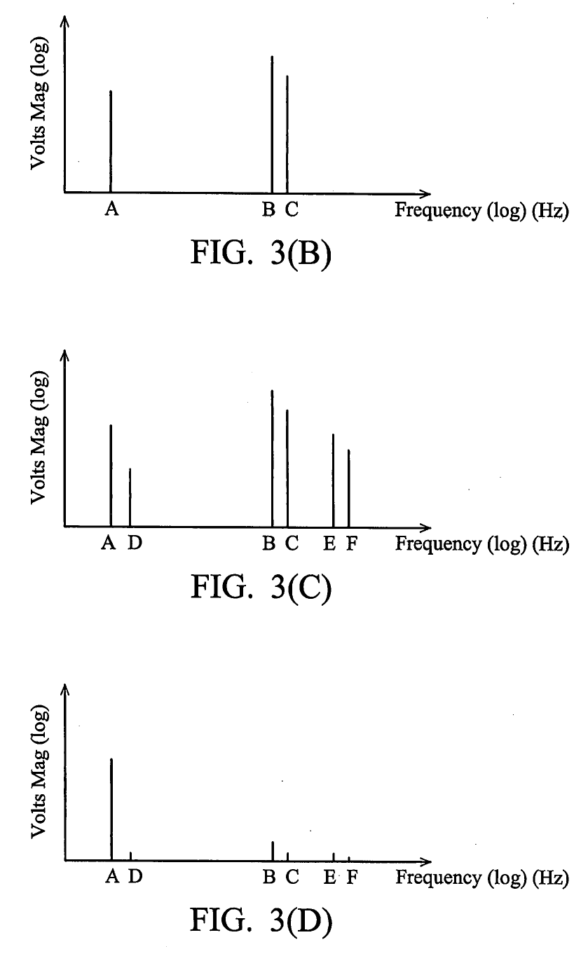

FIG. 3(A) shows a preferred embodiment of an ECM according to the invention. Microphone 300 is an equivalent model comprising a transducer 301, an inductor 318, a capacitor 320, a pair of diodes 304 and 306, a RF filter 308, a preamplifier 310, and an analog-to-digital converter (ADC) 312.

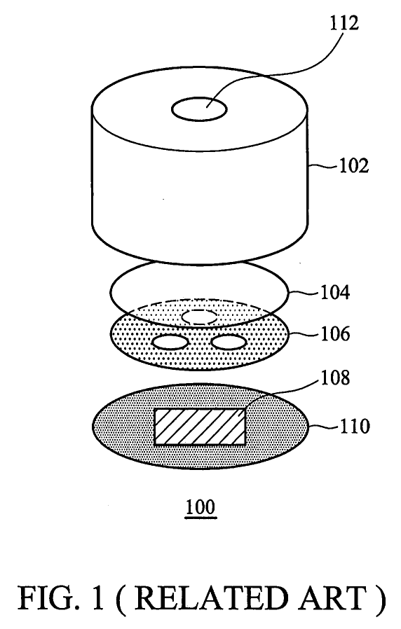

Transducer 301 is an equivalent model of a diaphragm (e.g. 104 in FIG. 1) and a backplate (e.g. 106 in FIG. 1), comprising a voltage source 314 and a capacitor 316. The diaphragm and the backplate together form a capacitor. The capacitance between the diaphragm and the backplate changes according to the received sound signal. Either the diaphragm or the backplate is coated with a charge storage layer (also referred to as electret). The charge storage layer is pre-polarized by an electric field with a voltage such as 200V. The built-in voltage is therefore 200V.

The pre-charged charge on the electret remains the same during operation since there is no leakage path of the electret. The voltage across the capacitor and the capacitance of the capacitor when the diaphragm moves x (which is a bias from a balance point) are respectively V(x) and C(x). The following equations hold:

$$Q = C ( x = 0 ) \cdot V ( x = 0 ) = C ( x ) \cdot V ( x )$$

$$C ( x ) = {ɛ}_{0} \frac{A}{{x}_{0} + x}$$

where ∈₀ is dielectric constant =8.85×10⁻¹⁴, A is the area of the capacitor (or equivalently, the area of diaphragm), x0 is the spacing between the diaphragm and the backplate at the balance point (i.e. no sound input), and x is the additional movement biased from the balance point.

Accordingly, the voltage across the capacitor is proportional to the input sound level. Therefore, the sound pressure can be translated into voltage signal across the capacitor. In addition, the first voltage signal V1 generated by transducer 301 is proportional to the input sound pressure and has a frequency band within 20 Hz˜20 kHz. The capacitance of capacitor 316 is about 5 pF˜10 pF for modern ECMs. The second voltage signal V2 induced from an external EM wave penetrating into microphone 300 interferes the first voltage signal V1. The EM wave is a high-frequency signal which may be generated from a wireless communication system transmitter, such as a Global System for Mobile Communications (GSM), a General Packet Radio Service (GPRS), a Personal Handyphone System (PHS), an Enhanced Data rates for GSM Evolution (EDGE), a Code Division Multiple Access 2000 (CDMA2000), a Wideband Code Division Multiple Access (WCDMA), and a Wireless Local Area Network (WLAN), or others. Therefore, the second voltage signal V2 is also a high-frequency voltage signal. For example, the second voltage signal V2 may be generated from a WLAN transmitter and has a frequency band with the central frequency at 5 GHz.

In the embodiment, diodes 304 and 306, RF filter 308, pre-amplifier 310, and ADC 312 are encapsulated in a microphone integrated circuit (IC) 302, and transducer 301 is electrically coupled to microphone IC 302 through bonding wires (not shown) and pads (not shown) of microphone IC 302. The bonding wires can be modeled as inductor 318 and the pads can be modeled as capacitor 320. The pair of diodes 304 and 306, electrically coupled to the ground and preamplifier 310 through RF filter 308, can be regarded as a resister with extremely large resistance (e.g. 100 GΩ) that helps provide the ground voltage as a DC bias voltage to preamplifier 310 and accordingly allows a lower cut-off frequency (e.g. 1 Hz) than usual resistors.

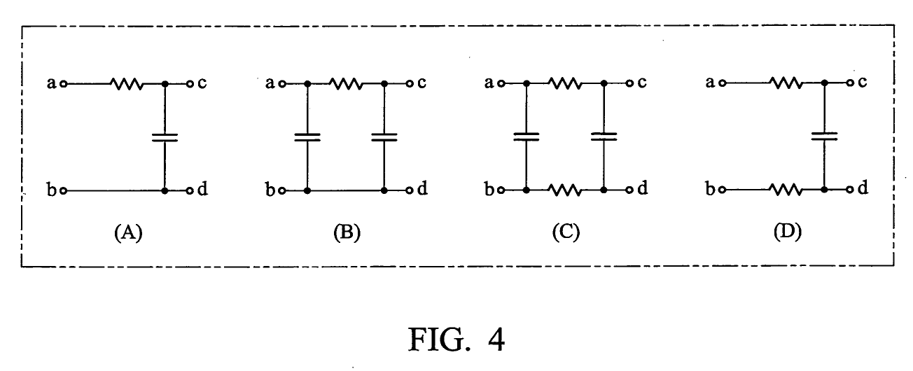

RF filter 308 electrically coupled to transducer 301 through the bonding wires and the pads is a low-pass filter used to filter out the second voltage signal V2 induced from the EM wave. For example, RF filter 308 may provide a unity gain at the voice band 20 Hz˜20 kHz and strongly attenuates the gain at 900 MHz˜5 GHz. FIG. 4 shows four embodiments (A)-(D) of RF filer 308, which are different types of resistor-capacitor networks. It is noted that RF filer 308 must consist of linear devices, such as resistor, capacitor, and inductor, otherwise RF filter 308 will also result in inter-modulation. Input ports a and b are electrically coupled to transducer 301, and output ports c and d are electrically coupled to preamplifier 310. Those with ordinary skill in the art can appreciate that other forms of resistor-capacitor networks consisting of a low-pass filter can be realized without departing from the invention. It is noted that the pair of diodes 304 and 306 can also be regarded as linear devices (because they work as resistors with extremely large resistance), so those with ordinary skill in the art would appreciate that the positions of the pair of diodes 304 and 306 and RF filter 308 showing in FIG. 3(A) can be exchanged due their linear characteristics.

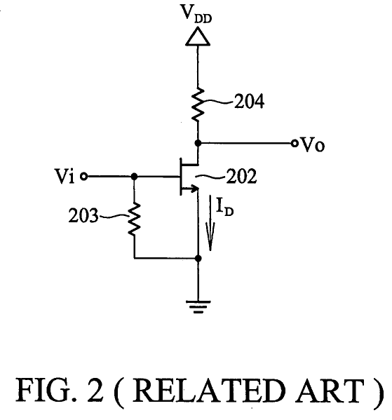

Preamplifier 310 is electrically coupled to RF filer 308, receives the filtered first voltage signal V1 and amplifies it. Preamplifier 310 can be a JFET shown in FIG. 2, where the gate of JEFT is connected to the output port c, and the source of JEFT and the output port d are both connected to the ground. Preamplifier 310 is used to drive consecutive circuits, such as ADC 312, because capacitor 316 is high-impedance and cannot drive a low input impedance circuit. The input impedance of preamplifier 310 should be as high as 1 GΩ˜100 GΩ; otherwise, the first voltage signal V1 would attenuate at low frequency. ADC 312 is electrically coupled to preamplifier 310 and can convert the amplified voltage signal V1 to a digital signal for further processing, such as recording in a flash memory, editing in a notebook, and transferring to a remote device through a wireless network, or others.

One advantage of the preferred embodiment is that RF filter 308 filters out the high frequency component (i.e. the second voltage signal V2) from the interfered first voltage signal V1 before preamplifier 310 amplifies it, thereby preventing preamplifier 310 from generating a low-frequency component (i.e. the inter-modulation term) that interferes with the original sound signal. For example, referring back to FIG. 3(B), the sound signal A and the RF signals B and C are filtered by RF filter 308 before passing through the preamplifier 310 in the embodiment. FIG. 3(D) shows the frequency spectrum after the sound signal A and the RF signals B and C pass through the preamplifier 310. It can be appreciated that the inter-modulation tone D and the harmonic tones E and F are deeply suppressed because the RF signals B and C are attenuated by RF filter 308. Additionally, the inter-modulation tone D would disappear if the RF signals B and C are filtered out completely. Another advantage of the preferred embodiment is that RF filter 308 also damps the resonant frequency component resulting from the bonding wires and the pads before preamplifier 310 amplifies it. The bonding wires equivalent to inductor 318 and the pads equivalent to capacitor 320 consist of an inductor-capacitor network that results in a highly resonant frequency component.

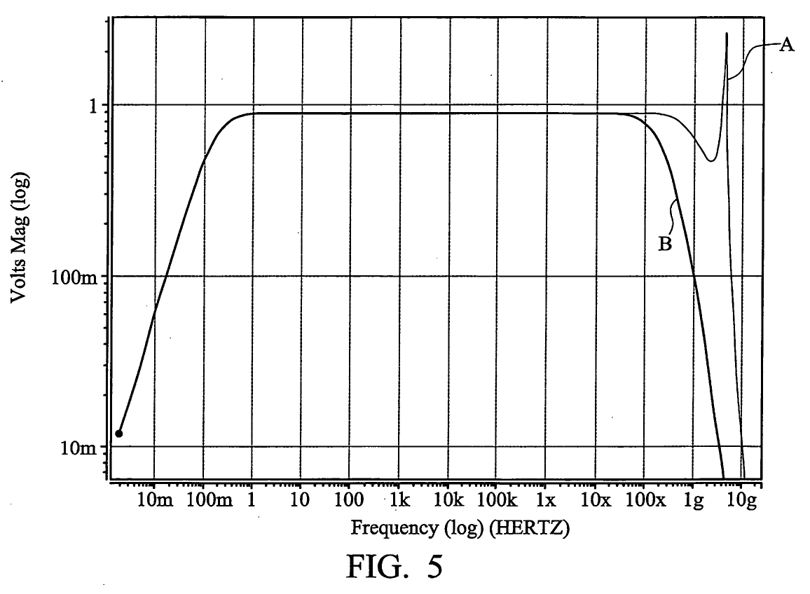

FIG. 5 shows an example of frequency response of microphone 300 with and without RF filter 308. The abscissa is frequency represented in log scale, and the ordinate is the voltage magnitude also represented in log scale. Curve A is the frequency response of microphone 300 without RF filter 308, and it shows a strong resonant peak at about 5 GHz. On the other hand, Curve B is the frequency response of microphone 300 with RF filter 308, and the resonant peak is effectively damped by RF filter 308.

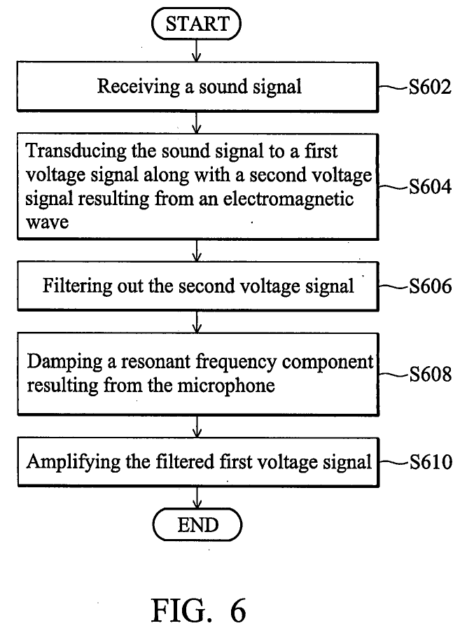

FIG. 6 shows an embodiment of audio processing method used in a microphone according to the invention. Firstly, a sound signal is received (Step S602). Next, the sound signal is transduced to a first voltage signal (Step S604). The first voltage signal is interfered with by a second voltage signal resulting from an electromagnetic wave penetrating into the microphone. Next, the second voltage signal is filtered out from the interfered first voltage signal (Step S606). In one embodiment, filtering out the second voltage signal comprises filtering out a frequency component higher than the frequency band of the sound signal (e.g. 20 Hz˜20 kHz). For example, the frequency component is at the range 900 MHz˜5 GHz. In another embodiment, filtering out the second voltage signal further comprises filtering out the frequency band of some telecommunication systems, such as a GSM, a GPRS, a PHS, an EDGE, a CDMA2000, a WCDMA, and a WLAN, or others. Next, a resonant frequency component resulting from the microphone itself is damped (step S608). In one embodiment, the resonant frequency component is at 5 GHz. Finally, the filtered first voltage signal is amplified (Step S610).

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An audio processing method used in a microphone, comprising:
receiving a sound signal;
transducing the sound signal to a first voltage signal, wherein the first voltage signal is interfered with by a second voltage signal resulting from an electromagnetic wave penetrating into the microphone;
filtering out the second voltage signal from the interfered first voltage signal; and
amplifying the filtered first voltage signal.

2. The audio processing method as claimed in claim 1, wherein filtering out the second voltage signal further comprises filtering out a frequency component higher than a frequency band of the sound signal.

3. The audio processing method as claimed in claim 2, wherein the frequency component is at the range from 900 MHz to 5 GHz.

4. The audio processing method as claimed in claim 1, further comprising damping a resonant frequency component resulting from the microphone.

5. The audio processing method as claimed in claim 4, wherein the resonant frequency component is at 5 GHz.

6. The audio processing method as claimed in claim 1, wherein filtering out the second voltage signal further comprises filtering out the frequency band of GSM, GPRS, PHS, EDGE, CDMA2000, WCDMA, or WLAN.

7. An audio processing system, comprising:
a transducer, configured to transduce a sound signal to a first voltage signal, wherein the first voltage signal is interfered with by a second voltage signal resulting from an electromagnetic wave;
a filter, electrically coupled to the transducer, configured to filter out the second voltage signal; and
a preamplifier, electrically coupled to the filter, configured to amplify the first voltage signal.

8. The audio processing system as claimed in claim 7, wherein the filter provides an unity gain at an audio band from 20 Hz to 20 kHz and strongly attenuates the gain at a frequency band from 900 MHz to 5 GHz.

9. The audio processing system as claimed in claim 7, wherein the filter is a resistor-capacitor network.

10. The audio processing system as claimed in claim 7, wherein the filter and the preamplifier are encapsulated in an integrated circuit electrically coupled to the transducer through a bonding wire and a pad.

11. The audio processing system as claimed in claim 10, wherein the filter is further configured to damp a resonant frequency component resulting from the bonding wire and the pad.

12. The audio processing system as claimed in claim 10, wherein the integrated circuit further comprises an analog-to-digital converter electrically coupled to the preamplifier and configured to convert the amplified first voltage signal to a digital signal.

13. The audio processing system as claimed in claim 7, further comprising a pair of diodes configured to provide a DC bias voltage to the preamplifier.

14. The audio processing system as claimed in claim 7, wherein the transducer comprises a diaphragm and a backplate, which together form a capacitor having a variable capacitance changed by the sound signal.

15. The audio processing system as claimed in claim 14, wherein either the diaphragm or the backplate is coated with a charge storage layer pre-polarized by an electric field.
